(19) United States
(12) Patent Application Publication
(10) Pub. No.: US 2010/0084377 A1
(43) Pub. Date: Apr. 8, 2010

(54) Method for Girth Welding Metallic Pipes

(76) Inventors: Antonio Belloni, Lodi (IT); Marco Belloni, Lodi (IT)

Correspondence Address: GABLE & GOTWALS, 100 WEST FIFTH STREET, 10TH FLOOR, TULSA, OK, 74103, US

(21) Appl. No.: 12/593,561

(22) PCT Filed: Mar. 17, 2008
(86) PCT No.: PCT/US08/03510

§ 371 Date: Sep. 28, 2009

(30) Foreign Application Priority Data
Mar. 29, 2007 (IT) PD2007A000117

(51) Int. Cl. F16L 9/22; B23K 9/00

(52) U.S. Cl. 219/59.1; 138/155; 138/109

(57) ABSTRACT

A method for girth welding of metallic pipes consists in beveling one pipe end in order that, when it is aligned with an identically beveled pipe end on another pipe, results in a bevel of a “cruet” design with a rounded bottom part larger than an upper part with parallel walls. The diameter of the welding wire used for the welding method is within 1.2 and 1.4 mm and the wire contains low levels of impurity including sulfur and phosphorus. The welding technique used is a “strip” technique which does not provide employ weaving or oscillation of the welding torch.

### BACKGROUND OF THE INVENTION

This invention relates generally to the joining of metallic pipes and more particularly concerns girth welding metallic pipes to form pipelines used to carry oil, gas and water.

Various known welding methods are used to connect metallic pipes together to form pipelines of desired lengths, diameters and thicknesses. Welding is the most critical operation in pipeline construction because of its significance in relation to mechanical resistance and pipeline productivity. These various welding operations are performed in the field during pipeline construction. In pipeline construction, working times, including man-hours and equipment operating times, are important. These times are mainly determined by the welding operations performed and are a function of the number of weld passes required as well as of the thickness of the pipe being welded. When a new pipe is welded to a pipeline, welding is performed with the pipeline maintained in stationary position so as to prevent cracks in the weld. The thickness of the upstream or first weld station weld passes, including root passes and in some cases hot passes, should be as high as possible to prevent risk of stress-induced failure due to subsequent pulling of the pipeline with added downstream pipe.

In the typical welding process, the two pipe ends to be joined are beveled and aligned to form a composite bevel that will be filled by a welding wire melted by an electrical arc. According to the known technical trend, the composite bevel is of the “open” type, having a substantially V-shaped section with its walls diverging at a certain angle. With this “open” type of bevel, the root pass, being the deeper pass, is made by use of the “strip” technique in which the welding torch running the wire is perpendicular to the pipe axis and remains fixed. Subsequently, as welding moves away from the root pass and the composite bevel becomes wider, the torch is oscillated in order to fill the wider bevel. Consequently, the time for filling consecutive passes increases because the widening bevel requires more filling material. Thus, the time for filling a bevel is a function of the angle of the “open” bevel.

It is, therefore, an object of this invention to provide a pipe welding method suitable to perform butt welding of pipes into a pipeline in a relatively short period of time. Another object of this invention is to provide a pipe welding method suitable to result in a sound weld using the “strip” technique from the root to the last fill pass. It is also an object of this invention to provide a pipe welding method which permits pulling the pipeline a short time after the welding operation is begun at the first welding station. A further object of this invention is to provide a welding method practicable with any mechanized/automatic welding system presently used for pipeline welding.

### SUMMARY OF THE INVENTION

In accordance with the invention, a method is provided for girth welding of metallic pipes, particularly for pipelines carrying gas, oil and water. The extremities of two pipes are beveled so that they can be aligned in such a way that the combined bevels result in a “cruet” shaped cross-sectional design with a narrow neck and a wider body. Thus, the pipe ends are beveled so that, when they are abutted, a bevel of “cruet” design is formed, preferably with a root portion rounded and larger than the remainder of the cruet shape which has parallel walls. The pipes are welded by filling the bevel with weld passes. Filling is accomplished by depositing filler wire in the bevel, preferably by using a “strip” technique with filler wire of diameter in a range of 1.2-1.4 mm. The filler wire desirably has a special chemistry affording a low content of sulfur, a low content of phosphorus and/or low melting point impurities. The maximum preferred sulfur content in the filler wire is 0.010%. The maximum preferred phosphorus content in the filler wire is 0.010%. Preferably, the neck cross-section has parallel walls and a width of 5.5 mm and the body cross-section has a maximum width of 6.5 mm. The method is applied for girth welding of pipelines to carry gas, oil and water laid with horizontal or semi-horizontal axis according to the so called “S” lay technique and with vertical or semi-vertical axis according to the so called “J” lay technique.

The pipe consists of lengths of metal tubing with leading and trailing end faces in parallel planes. Bevels in each end face are contoured so that, with a trailing end of a first pipe in abutment with a leading end of a second pipe, abutting bevels define a cruet-shaped cross-section having a neck and a body. The neck has an open mouth at an outer perimeter of the abutting pipes. The widest width of the body is greater than the widest width of the neck. For cylindrical tubing, the end faces are in radial planes and the cruet-shaped cross-section is symmetrical in relation to the abutting end face planes. Preferably, the neck of the cross-section has parallel side walls and the body of the cross-section has a rounded bottom and side walls which taper to the neck side walls.

### BRIEF DESCRIPTION OF THE DRAWINGS

Other objects and advantages of the present invention will become apparent upon reading the following detailed description and upon reference to the drawings in which:

FIG. 1 is a cross-sectional view of the “cruet” shaped bevel formed by abutting ends of pipe;

FIG. 2 is a cross-sectional view of the “cruet” shaped bevel illustrating the initial welding phase of root weld passes deposited in the bottom of the inner bevel portion;

FIG. 3 is a cross-sectional view of the “cruet” shaped bevel illustrating a welding phase of weld passes filling the inner bevel portion up to parallel side walls of the bevel;

FIG. 4 is a cross-sectional view of the “cruet” shaped bevel illustrating a welding phase of weld passes filling the outer bevel portion between parallel side walls; and

FIG. 5 is a cross-sectional view of the “cruet” shaped bevel illustrating weld passes capping the bevel in the final phase of welding.

While the invention will be described in conjunction with a preferred embodiment thereof, it will be understood that it is not intended to limit the invention to that embodiment or to the details of the construction or arrangement of parts illustrated in the accompanying drawings.

### DETAILED DESCRIPTION

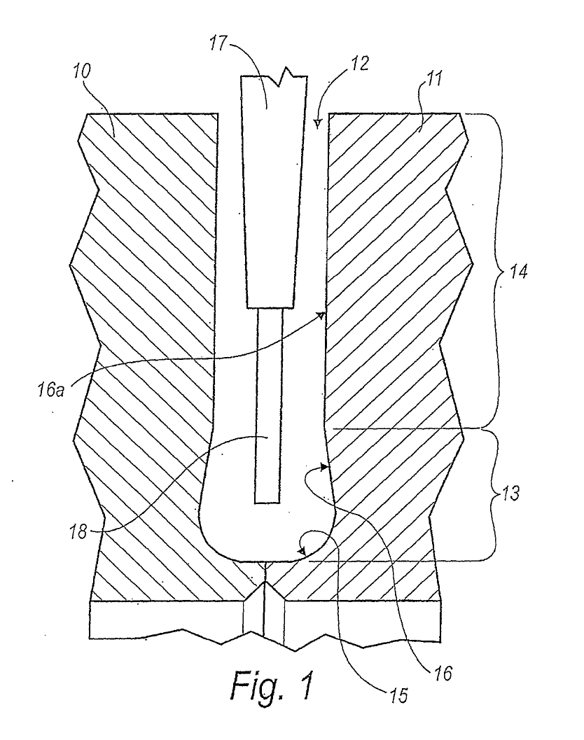

Turning first to FIG. 1, the aligned ends 10 and 11 of left and right pipes, respectively, are identically machined in order to obtain a bevel 12. The bevel 12 has a “cruet” shape defined in relation to direction of the radii of the pipes by an inner part 13 and an outer part 14. The inner part 13 has a rounded zone 15 which is shown as the bottom of the cruet section but which extends circumferentially about the aligned pipes. The rounded zone 15 is connected to the outer part 14 of the cruet section by the line 16. The line 16 is, as shown, the upper wall of the rounded zone 15. The outer part 14 of the “cruet” shaped bevel 12 is formed by the wall 16a which, as shown, is perpendicular to the axis of the aligned pipes. The numbered identifiers are shown with respect to the right pipe end 11, but should be considered the same for the other pipe end 10, the pipe ends 10 and 11 being identical. FIG. 1 also shows a welding torch 17 feeding the welding wire 18 into the bevel 12.

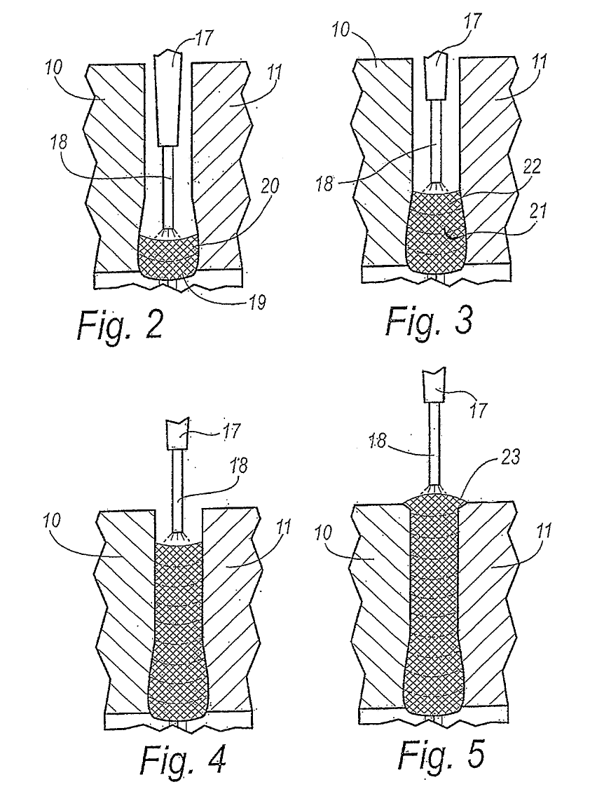

Looking at FIGS. 2, 3, 4 and 5, four welding phases are illustrated schematically. As seen in FIG. 2, welding starts with a root pass 19 deposited by a strip technique end melting pipe ends 10 and 11 at the bottom or inner part 13 of the bevel 12 forming a bead that protrudes internally into the rounded zone 15. A second pass 20 applied over the root pass 19 also forms a bead that protrudes internally into the rounded zone 15. Continuing on to FIG. 3, passes 21 and 22 are seen to complete welding of the bottom or inner part 13 of the bevel 12, being the part of the bevel 12 with larger section. Looking at FIG. 4, continued prosecution of welding by sequential passes in the strip technique is seen to almost fill the outer part 14 of the bevel 12. Finally, as seen in FIG. 5, the weld is completed by a cap pass 23. Each of the single passes is made using the strip technique except possibly the cap pass 23 which could require oscillation of the wire 18.

To obtain a top quality weld, a welding wire 18 of 1.2-1.4 mm diameter range is required. The width of the bevel 12 in the top zone or outer portion 14, assuming parallel walls 16a, will be in the order of 5.5 mm. The welding wire 18 must contain a very low level of sulfur and phosphorus as well as low melting point impurity. In these conditions a weld free of centerline cracks is obtained and, by use of the strip technique, all weld passes are deposited at high speed. This facilitates the reduction of the working times. The first or root welding pass that melts and fills the rounded zone 15 in the bottom or inner part 13 of the bevel 12 establishes a robust conjunction of the new pipe to the pipeline so as to enable movement of the pipeline in a short time.

The great advantage of this welding method over the transverse oscillation of the torch is that it performs a very homogeneous weld of quality in line with the major International Standards for pipeline welding.

This welding method may be applied to girth welding of pipelines carrying gas, oil and water, whether laid with horizontal or vertical axis, according to the so called “S” or “J” lay techniques.

Thus it is apparent that the objects and advantages stated above are satisfied by the method and beveled pipe herein disclosed. A new welding method has been developed having the main characteristics of using a pipe end face bevel with a “cruet” shape.” The soundness of the weld is obtained not only by the “cruet” shape” of the bevel, but by the use of a welding wire of relatively large diameter and high purity.

The specific embodiment shown of the present invention may be the subject of modifications and variations all within the inventive concept and furthermore all details may be substituted for by technical equivalents.

What is claimed is:

1. A method for girth welding of metallic pipes particularly for pipelines carrying gas, oil and water comprising the steps of:
bevelling the two pipe extremities to be aligned and welded in such a way that the obtained bevel has a “cruet” shaped cross-sectional design with a narrow neck and a wider body; and
filling the bevel with weld passes.

2. A method according to claim 1, said step of filling comprising depositing filler wire in the bevel.

3. A method according to claim 2, said step of depositing being performed using a “strip” technique.

4. A method according to claim 3, said step of depositing being performed using a filler wire of diameter in a range of 1.2-1.4 mm.

5. A method according to claim 3, said step of depositing being performed using a filler wire with a low content of sulfur.

6. A method according to claim 5, a maximum sulfur content in the filler wire being 0.010%.

7. A method according to claim 3, said step of depositing being performed using a filler wire with a low content of phosphorus.

8. A method according to claim 7, a maximum phosphorus content in the filler wire being 0.010%.

9. A method according to claim 3, said step of depositing being performed using a filler wire of low melting point impurities.

10. A method according to claim 1, the neck cross-section having parallel walls.

11. A method according to claim 10, the neck cross-section having a width of 5.5 mm.

12. A method according to claim 1, the body cross-section having a maximum width of 6.5 mm.

13. A method according to claim 1 applied for girth welding of pipelines to carry gas, oil and water laid with horizontal or semi-horizontal axis, according to the so called “S” lay technique.

14. A method according to claim 1 applied for girth welding of pipelines to carry gas, oil and water laid with vertical or semi-vertical axis, according to the so called “J” lay technique.

15. A method for girth welding pipelines to carry gas, oil and water, characterized by the fact of including the above claimed characteristics as described and illustrated for the specific scopes.

16. A pipe comprising;
a length of metal tubing having leading and trailing end faces in parallel planes;
a pair of bevels, one in each said end face, said bevels having a contour such that, with a trailing end of a first pipe in abutment with a leading end of a second pipe, abutting bevels define a cruet-shaped cross-section having a neck and a body, said neck having an open mouth at an outer perimeter of the abutting pipes.

17. A pipe according to claim 16, a widest width of said body being greater than a widest width of said neck.

18. A pipe according to claim 17, said tubing being cylindrical and said end faces being in radial planes.

19. A pipe according to claim 18 and said cruet-shaped cross-section being symmetrical in relation to said end face planes.

20. A pipe according to claim 19, said neck of said cross-section having parallel side walls.

21. A pipe according to claim 20, said body of said cross-section having a rounded bottom and side walls tapering to said neck side walls.
